(19) United States
(12) Patent Application Publication
(10) Pub. No.: US 2026/0174000 A1
(43) Pub. Date: Jun. 25, 2026

(54) Seed Delivery System

(71) Applicant: AGCO do Brasil Soluções Agrícolas Ltda., Jundiaí (BR)

(72) Inventors: Vinicius Felipe Fior, Canoas (BR); Cassiano Zanatta, Ibirubá (BR); Venicius Damo Cunha, Não Me Toque (BR)

(21) Appl. No.: 19/127,638

(22) PCT Filed: Oct. 3, 2023
(86) PCT No.: PCT/IB2023/059906

§ 371 Date: May 6, 2025

Related U.S. Application Data
(60) Provisional application No. 63/385,747, filed on Dec. 1, 2022.

(51) Int. Cl. A01C 7/10; A01C 7/04

(52) U.S. Cl. CPC A01C 7/102; A01C 7/0443

(57) ABSTRACT

A seed delivery system comprises first (200) and second (202) storage vessels for storing first and second materials to be provided to the ground and first (230) and second (240) distribution arrangements for delivering the first and second materials to the ground. The first material comprises seeds and the first distribution arrangement comprises a seed metering unit. A sensor arrangement (350) is used for sensing at least a seed flow rate to the ground and a second material flow rate to the ground and a controller (354) is provided for automatically controlling an air pump arrangement (210) in dependence on a desired seed delivery rate and a desired delivery rate of the second material, and using feedback from the sensor arrangement.

### CROSS-REFERENCE TO RELATED APPLICATION

This application claims the benefit of the filing date of U.S. Provisional Patent Application 63/385,747, “Seed Delivery System,” filed Dec. 1, 2022, the entire disclosure of which is incorporated herein by reference.

### FIELD

Embodiments of the present disclosure relate generally to seed delivery systems, and in particular pneumatic air seeders or planters which are able to deliver multiple seeds, or to deliver a combination of dry fertilizer and seeds, to a field.

### BACKGROUND

Air seeders and planters are commonly towed by tractors to apply seed or fertilizer, or both simultaneously, to a field. An air seeder or planter is for example used in combination with a tilling implement, both towed behind a tractor, to place seed and fertilizer into a furrow which is opened by the tilling implement. Air seeders and planters comprise one or more product tanks for holding product, generally seed or fertilizer or both. Air seeders and planters also typically include a dosing system for dispensing product from the tanks and a pneumatic distribution system for delivering the product from the tanks to the soil. This initial dosing system for example comprises an auger or roller.

The product tanks are for example pressurized with air from the pneumatic distribution system. The pneumatic distribution system for example uses a centrifugal fan to provide at least one airstream which flows through the pneumatic distribution system to separate manifolds at which seed boots deposit product in the soil. The seed boots are arranged in a line, to form rows of planted seeds.

In one typical design, product is first introduced to the air stream in the vicinity of the product tank by the dosing system, using a venturi in a plenum of the dosing system. Product is carried by the air stream through distribution lines to the seed boots, which function as distribution units. The seeds are singulated and metered typically using a seed metering disc with pockets or holes. The seed boots are mounted behind ground openers of the tilling implement so that the product may be evenly delivered to the ground.

In positive pressure seeding systems, some air is diverted from the pneumatic distribution system to the product tanks to pressurize the tanks. The product tanks are for example maintained at the same pressure as the airstream which carries product from the product tank.

Seeding systems enable a user to control the different components, such as the pressure source to vary the delivery airflow. Depending on the planter speed and the type of seed, the operator will adjust the air flow to maintain a desired seed distribution. The seed metering is for example controlled automatically.

However, this adjustment of the air flow is a difficult task for the operator, so that manual adjustment errors are common, resulting in a reduction in system efficiency, or incorrect seed distribution.

### BRIEF SUMMARY

A seed delivery system includes a first storage vessel for storing first material to be provided to the ground, the first material comprising seeds; a second storage vessel for storing second material to be provided to the ground; and a first distribution arrangement for delivering the first material to the ground. The first distribution arrangement comprises a seed metering unit. The system also includes a second distribution arrangement for delivering the second material to the ground, an air pump arrangement, a first channel arrangement for delivering the first material from the first storage vessel to the first distribution arrangement using an air flow from the air pump arrangement, a second channel arrangement for delivering the second material from the second storage vessel to the second distribution arrangement using an air flow from the air pump arrangement, a sensor arrangement for sensing at least a seed flow rate to the ground and a second material flow rate to the ground, and a controller for controlling the air pump arrangement. The controller is configured to control the air pump arrangement in dependence on a desired seed delivery rate and a desired delivery rate of the second material, using feedback from the sensor arrangement.

This seed delivery system provides automatic control of the components of the delivery system to enable a desired delivery rate to be maintained, using feedback sensors which monitor the material flow rates and pressure generated by the air pump arrangement. By adjusting parameters of the delivery system automatically based on sensed conditions, the efficiency of the system may be improved, reducing fuel consumption of the tractor pulling the seed delivery system.

The controller is for example configured to control the air pump arrangement to control the air flow for the delivery of the first and second materials independently. For example, there may be independent control of a seed delivery rate and a fertilizer delivery rate.

The seed metering unit for example may be a seed disc having compartments for holding individual seeds, wherein the controller is configured to control a rotation speed of the seed disc. The rotation speed of the disc determines the seed delivery conditions achieved by the seed metering unit. Thus, the automatic control may be used for automatic control of the airflow delivered by the air pump arrangement as well as the seed metering function.

The seed metering unit for example may include a vacuum pump for delivering a vacuum to the seed disc, wherein the sensor arrangement further comprises a pressure sensor for monitoring the vacuum level.

The controller may be further configured to control the vacuum pump in dependence on the monitored vacuum level using feedback from the sensor arrangement. Thus, the seed disc rotation and vacuum pressure of the pneumatic seed metering system may also be controlled.

The sensor arrangement for example may include a pressure sensor for measuring a first pressure generated for seed transport and a second pressure generated for transport of the second material. Thus, the pressures in the two delivery circuits may be used as feedback signals.

The sensor arrangement can be used for measuring, or receiving, a ground speed of the seed delivery system. Thus, a seed delivery rate per unit distance can be monitored. The ground speed may be for example speed of the tractor pulling the seed delivery device.

In one set of examples, the pump arrangement may comprise a first air pump and a second air pump, wherein the first channel arrangement carries an air flow from the first air pump and the second channel arrangement carries an air flow from the second air pump. The two pumps can then be independently controlled.

In another set of examples, the air pump arrangement comprises a single air pump and an air splitter for splitting an output air flow from the air pump between first and second outlets, wherein the air splitter comprises a controllable valve for controlling a splitting ratio between the first and second outlets. The first channel arrangement is for delivering the first material from the first storage vessel using an air flow from the first outlet and the second channel arrangement is for delivering the second material from the second storage vessel to the second distribution arrangement using an air flow from the second outlet.

A single pump may therefore deliver an air flow which is then split between at least two different outputs. The air flow from each output is used to deliver material from an associated storage vessel to an associated distribution arrangement (e.g., at row units). By allowing the splitting ratio to be adjusted, the (relative) dosage of the first and second materials can be controlled. In combination with a control of the drive speed of the air pump, the two flow rates can be independently controlled. By setting a splitting ratio of 1 (or 0) the system can also be used for delivery of only one material, for example seed without fertilizer. Similarly, the system can be used only to deliver fertilizer. In each case, the drive speed of the air pump can be reduced accordingly. A single flow regulator may be used to regulate the output flow from the single air pump.

This arrangement can reduce the cost of the system in terms of the components needed, and can also simplify assembly.

The controller may then be further configured to control the air splitter, so that the two material flows can be controlled independently.

The first and second distribution arrangements for example each comprise a set of distribution units, wherein the seed delivery system comprises a set of row units, each with a respective first and second distribution unit. Each distribution arrangement thus comprises a set of distribution units spread across a set of rows of the seed delivery system.

The first material is seeds, as explained above. The second material may also comprise seeds, and the second discharge arrangement then comprises a seed metering system. Alternatively, the second material may comprise dry fertilizer and the second discharge arrangement then comprises a fertilizer nozzle. The control of the flow rate of fertilizer may be controlled at the second storage vessel rather than at the ground. In other embodiments, both materials may be fertilizer.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 shows a seed delivery system being towed behind a tractor;

FIG. 2 shows in schematic form the pneumatic connections in a seed delivery device;

FIG. 3 shows a first perspective view of the air splitter, from above;

FIG. 4 shows a second perspective view of the air splitter, from below;

FIG. 5 shows the air splitter in cut away view with the valve member removed;

FIG. 6 shows some parts of a row unit;

FIG. 7 shows a control system for controlling the air splitter; and

FIG. 8 shows a row unit in more detail.

### DETAILED DESCRIPTION

The illustrations presented herein are not actual views of any agricultural machine or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all the elements that form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

This disclosure relates to a seed delivery system which comprises first and second storage vessels for storing first and second materials to be provided to the ground and first and second distribution arrangements for delivering the first and second materials to the ground. The first material comprises seeds and the first distribution arrangement comprises a seed metering unit. A sensor arrangement is used for sensing at least a seed flow rate to the ground and a second material flow rate to the ground and a controller is provided for automatically controlling the air pump arrangement in dependence on a desired seed delivery rate and a desired delivery rate of the second material, and using feedback from the sensor arrangement.

There are many different types of seed delivery system. For large scale agriculture, the seed delivery system is towed behind a tractor and comprises a wide boom, defining a set of rows. Each row has a row unit where the delivery of seeds into the ground takes place. In pneumatic systems, air flow is used to deliver seeds from a seed tank to the row units.

Some seed delivery systems volumetrically meter the seeds at the location of the seed tank, and then deliver the metered seeds to the row unit. The row unit may then simply comprise a seed boot. This arrangement is generally known as an air seeder.

Other seed delivery systems perform initial dosage of the seeds using a distribution unit at the location of the seed tank, and the row units have a receiving chamber which fills up and the row units create a flow of singulated seeds. When the receiving chamber is full, the air flow is interrupted, stopping flow of material into the receiving chamber. At the row unit, the seeds are singulated and delivered to the ground by a seed metering unit. This for example involves a rotary disc comprising seed cells into which individual seeds are received, and the disc is rotated (e.g., by an electric drive) to deliver seeds one at a time from the receiving chamber. The row unit has a vacuum pump to deliver a vacuum pressure to hold the seeds in the seed cells, and the vacuum is released when the disc rotates to allow the seeds to drop one at a time from the rotary disc into a furrow. This arrangement is generally known as a planter.

Most seed delivery systems open a furrow into which the seeds are dropped. For this purpose, a trench opener (or furrow opener) is at the front of the row unit (in the direction of travel) before the seed discharge system, and a closing wheel is at the back of the unit to close the furrow.

This disclosure relates to any configuration of seed delivery system in which material (including seeds) is delivered from a tank to a set of row units using an air flow generated by positive air pressure, and in which a seed metering unit is provided at the row units.

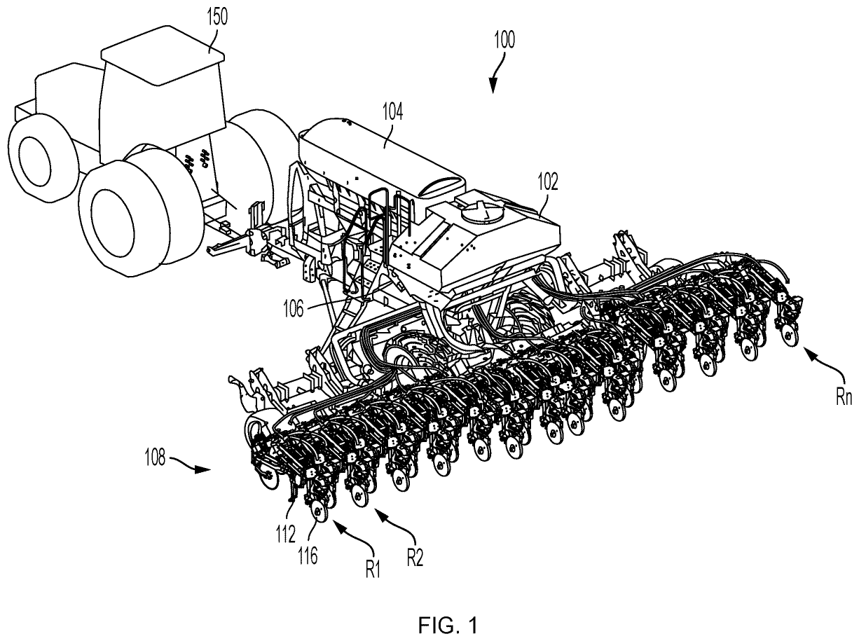

FIG. 1 shows a seed delivery system 100 being towed behind a tractor 150.

In this example, the seed delivery system comprises a first tank 102 for seeds and a second tank 104 for dry fertilizer. Each tank has its own air pump, for example the air pump for the first tank 102 is shown at 106. The air pumps each deliver material from their respective tank to the delivery head 108 which comprises a series of row units R1, R2, . . . , Rn. The air pump generates a flow of air, and seeds are introduced into the airflow at a venturi. The air flows, with entrained seeds and dry fertilizer, are conveyed to the row units by pipe connections.

Each row unit is designed to open a furrow, deliver individual seeds and into the furrow, deliver fertilizer to or near the furrow. In some designs, the delivery head may also close the furrow. Each row unit comprises a trench opener 116 and inside it there is a seed tube (seed boot) for delivering the seed. A fertilizer delivery nozzle 112 (shank) is also provided. Each row unit has a set of sensors for monitoring the functioning of the row unit.

This disclosure relates to the automatic control of the delivery of material to the ground. The concepts may be applied to a system with separate air pumps as described above (and which may together be considered to constitute “an air pump arrangement”) but there may instead be a single air pump shared between the two material tanks.

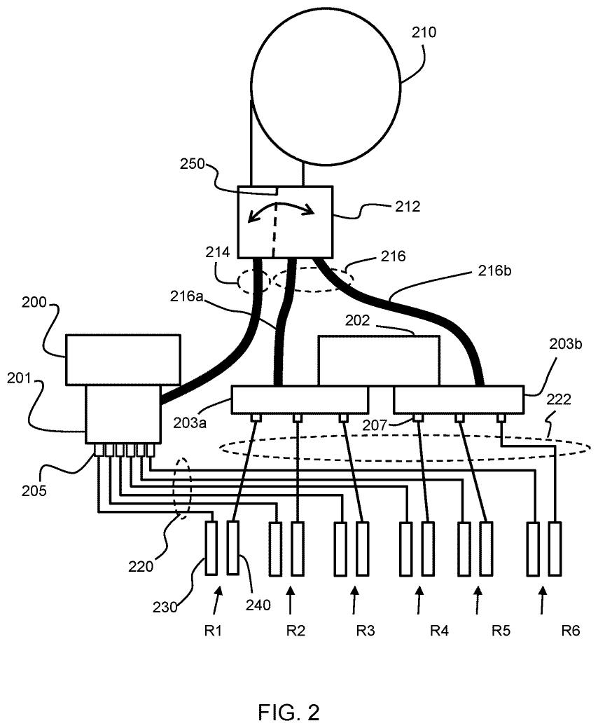

FIG. 2 shows in schematic form the pneumatic connections in a seed delivery device having a single air pump 210.

The seed delivery system comprises a first storage vessel 200 for storing first material to be provided to the ground and a second storage vessel 202 for storing second material to be provided to the ground. The first storage vessel has a distribution unit 201. In the example shown, there are two dosing units 203a, 203b for the second storage vessel 202. In this example, the first storage vessel 200 is for storing seeds and the second storage vessel 202 is for storing fertilizer.

The air pump 210 (which again may, even by itself, be considered to constitute an “air pump arrangement”) delivers an output air flow to an air splitter 212. The air splitter 212 splits the output air flow between a first outlet 214 and a second outlet 216. The air splitter 212 controls a splitting ratio between the first and second outlets 214, 216. In the example shown, the second output comprises first and second airflow exits 216a, 216b because this example has two dosing units 203a, 203b for the second storage vessel 202. However, there may only be one airflow exit, or there may be two (as shown) or even more airflow exits associated with the second outlet 216. There may also be multiple airflow exits for the first outlet if there are separate distribution units.

The air flow along each outlet is used to entrain a flow of material (seeds and fertilizer) from the storage vessel towards the row units. The air flow may pass through a venturi, for example venturis 205 of the distribution unit 201 and venturis 207 of the dosing units 203a, 203b, which creates an under-pressure to draw the seed or dry fertilizer into the air flow.

A first channel arrangement 220 is for delivering the first material, i.e., the seeds, from the storage vessel 200 to the row units and a second channel arrangement 222 is for delivering the second material, i.e., the fertilizer, from the storage vessel 202 to the row units. The row units, shown in simplified form as only rows R1 to R6 in FIG. 2, together constitute a first distribution arrangement for delivering the first material to the ground and a second distribution arrangement for delivering the second material to the ground. The first distribution arrangement comprises a set of units 230, with one such distribution unit 230 in each row unit. Each unit 230 comprises a seed metering system and a seed boot. The seed metering system comprises a seed disc, with the speed varied according to the dosing rate set by the operator. The second distribution arrangement comprises a set of distribution units 240, with one such distribution unit 240 in each row unit. Each unit 240 comprises a fertilizer delivery nozzle.

This seed delivery system thus has at least two storage vessels for different types of material. A single air pump is used to deliver an air flow which is then split between at least two different outputs. By allowing the splitting ratio to be adjusted, the relative dosage of the first and second materials can be controlled. In combination with control of the drive speed of the air pump, the two flow rates can be controlled. The system can be used to deliver fertilizer and seeds, fertilizer alone, or seeds alone. When delivering only one material, the drive speed of the air pump can be reduced accordingly. A single flow regulator may be used to regulate the output flow from the single air pump, whether the system is delivering one material or more.

The air splitter 212 comprises a pivotable valve member 250 which is rotatable about a pivot (e.g., a pin). The air splitter thus has a simple and reliable configuration as a flap valve which closes a selective one of the outlets, or else allows a partial airflow into both outlets.

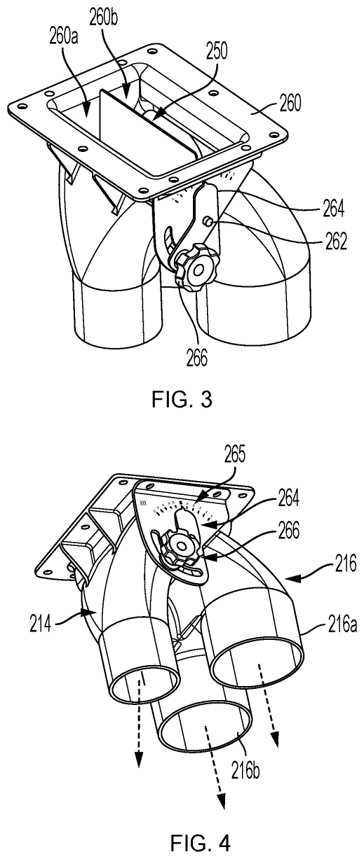

FIG. 3 shows a first perspective view of the air splitter, from above. It shows the inlet 260 to the air splitter, which connects to the outlet of the air pump. The inlet is divided into two regions 260a, 260b by the valve member 250. One region is fluidly coupled to the first outlet 214 and the other region is fluidly coupled to the second outlet 216 (which comprises two separate exit tubes in this example).

The valve member 250 rotates about a pivot pin 262. The valve member can be rotated to a position where it closes one or the other of the first and second outlets. An indicator, for example a pointer 264 which points to a scale 265, rotates with the valve member when the orientation of the valve member is changed, to indicate the selected position, and hence indicate the division of the air pump outlet flow between the two outlets. The pointer can be released and locked by a handle in the form of a locking knob 266, which thus also locks the valve member or allows its position to be adjusted.

FIG. 4 shows a second perspective view of the air splitter, from below. In the example shown, the position of the valve member is manually adjustable by the knob 266. However, an electrical actuator may be provided for adjusting the position of the valve member 250. This enables remote control of the air splitter, e.g., from the tractor cabin. Automated control of the air splitter may then also be implemented, for example based on feedback from sensors which sense seed delivery conditions or fertilizer delivery conditions, or as a function of the ground speed. A controller is then used for controlling the electrical actuator in dependence on the sensed conditions. By adjusting the air splitter automatically based on sensed conditions, the efficiency of the system may be improved. In embodiments having an electrical actuator, the pointer 264, scale 265, and/or locking knob 266 may be omitted.

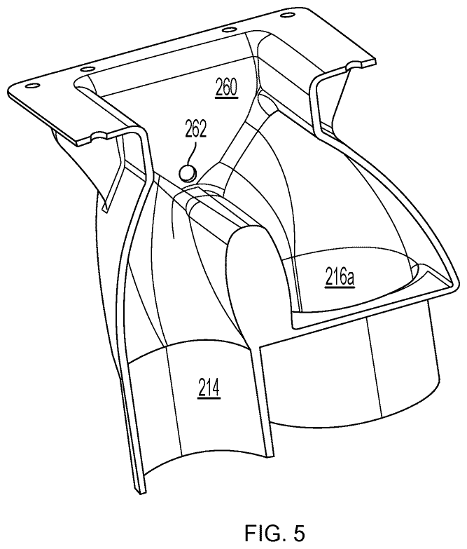

FIG. 5 shows the air splitter in cut away view with the valve member removed. It shows the two internal sides of the air splitter. The body of the air splitter is for example plastic, and the valve member is metal or plastic. The indicator (pointer and scale) are for example metal or plastic. Plastics may be used due to their chemical inertness and metals additionally have increased wear resistance.

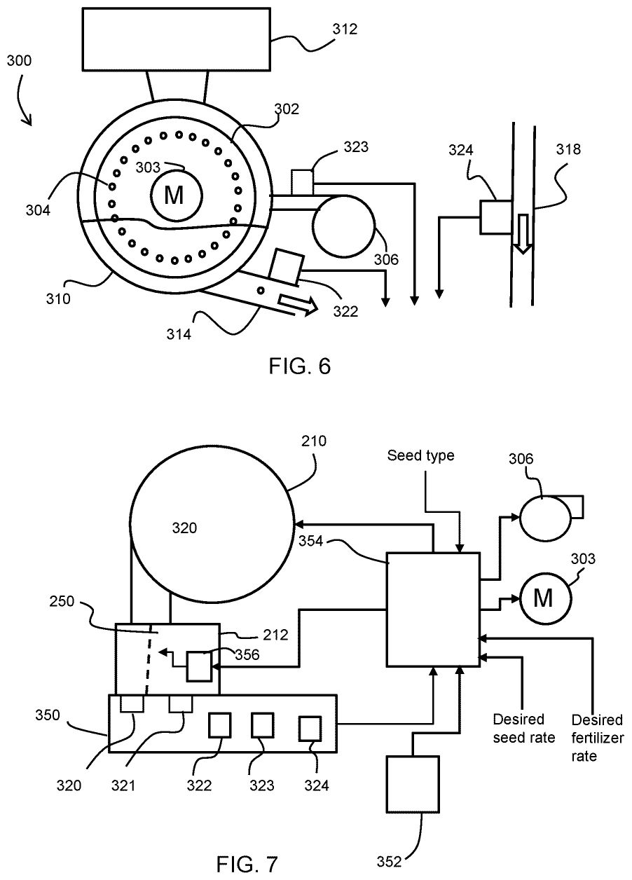

FIG. 6 shows in schematic form some of the parts of the row unit. The row unit comprises a pneumatic seed metering device 300. In this example, it comprises a rotary disc or plate 302 having one or more concentric circular rows of equally spaced apertures 304. The disc is driven at a controllable rotation speed by a motor 303. A vacuum is applied to one side of the disc by a vacuum pump 306, creating a negative pressure differential on opposite sides of the disc. In use, the disc rotates through a seed reservoir 310 located on the opposite side of the disc to which the vacuum is applied. The seed reservoir is fed by a local receiving chamber (hopper) 312 at the row unit. The receiving chamber is filled by the air flow from the pump 210, and the flow is interrupted when the receiving chamber is full.

The negative pressure differential causes seeds to be moved to, and held over, the apertures 304 as the apertures rotate through the seed reservoir.

Excess seeds are removed by a seed stripper and the individual seeds that remain entrained over the apertures are then dispensed one at a time to a discharge point 314 before the apertures re-enter the seed reservoir.

The row unit also comprises a fertilizer delivery nozzle 318.

This disclosure relates to the automatic control of the air pump which provides the delivery of seed and fertilizer (or more generally first and second materials), in particular using sensing of various conditions as well as the desired material delivery rate.

FIG. 6 shows the various sensors used for monitoring the performance of the row unit. The sensors shown are a seed flow rate sensor 322 for monitoring the seed delivery rate, a vacuum sensor 323 for measuring the vacuum level of the vacuum pump, and a fertilizer flow rate sensor 324 for monitoring the fertilizer delivery rate. The two flow rate sensors are for example optical sensors, although other sensors are possible.

FIG. 7 shows a control system for at least the air pump arrangement 210.

Sensors 350 are provided for sensing seed delivery conditions or fertilizer delivery conditions, such as the sensors 322, 323, 324 described above (e.g., seed delivery rate, fertilizer delivery rate, vacuum pressure) and a ground speed sensor 352 is provided (which could be an existing part of the tractor towing the seed delivery system).

The sensors also include a first pressure sensor 320 for monitoring the pressure provided for seed delivery and a second pressure sensor 321 for monitoring the pressure provided for fertilizer (or more generally second material) delivery. The sensed information is provided to a controller 354 which controls the air pump arrangement 210, and optionally also the components of the row unit. This disclosure however relates in particular to control of the air pump arrangement, and it may be applied to a single air pump or separate pumps. When a single pump is used, a single pressure sensor may be used, and the position of the valve member may be used to derive the different pressures in the two delivery systems.

In particular, the controller provides automatic control of at least the flow rate generated by the air pump arrangement 210, so that the delivery rate of the first and second materials to the row units is automatically controlled. If there are separate air pumps, they can be controlled separately. If a single pump is used, the pump speed and the valve member setting may be controlled. The controller also provides control of the vacuum level of the vacuum pump 306.

The controller receives as inputs the desired seed rate (e.g., seeds/meter) and the desired fertilizer rate (e.g., kg/hectare). A seed type input is also provided. These may be inputs provided by the operator. The feedback signals received by the controller are those described above: seed delivery rate, fertilizer delivery rate, pressure level(s) of the air pump arrangement and vacuum level.

Automatic control of the seed metering unit is also provided. For this purpose, the sensor arrangement may also sense fertilizer clogging, and duplicate or missing deposited seeds. These may be achieved with the same sensor e.g., optical sensor, as used for measuring the fertilizer delivery rate and the seed delivery rate.

The controller generates, as outputs, a control signal for the air pump arrangement 210. For the optional example using a single air pump and air splitter, an actuator 356 (e.g., an electrical actuator) is used to control the pivoting of the valve member 250 to provide a desired air splitting ratio, and the controller then also generates a control signal for the valve member 250 of the air splitter.

The air pump speed may be reduced when the machine is working as a seed-only planter. For the fertilizer, a high air flow (hence high air pump speed, such as 5800-6000 RPM) is maintained because the fertilizer is typically more difficult to transport to the row units. When having two products, and at least one of them is fertilizer, the position of the valve member 250 may be adjusted whereas the air pump speed is maintained, e.g., in the range 5800-6000 rpm. In this case, most of the air flow generated by the air pump will be directed to the fertilizer outlet 216.

Each seed type may for example have a default fan speed for a default seed delivery rate at a default ground speed. The controller will increase the fan speed for an increase in ground speed, or an increase in desired seed rate when performing only seed delivery. The fan speed is maintained regardless of fertilizer rate. Feedback of the actual delivery rates and pressure(s) enables the air pump flow rate delivered to the two distribution channels to be adjusted to achieve the desired rates set by the operator.

The example above is based on the delivery of seeds and dry fertilizer. However, the same arrangement may be used for delivery multiple seed types (with two metering units at each row unit) or multiple fertilizer types.

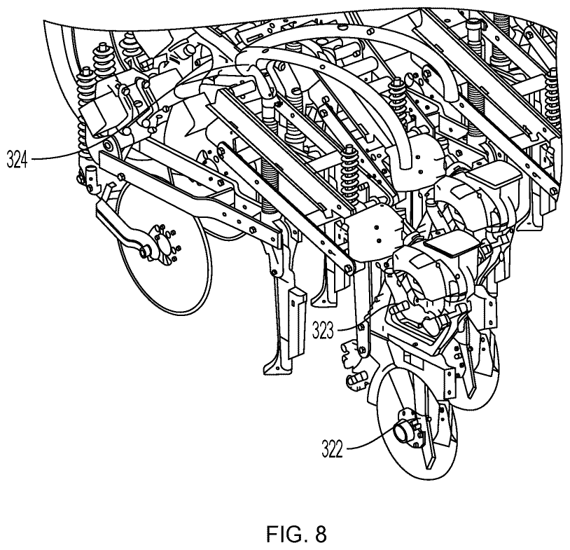

FIG. 8 shows the row units in more detail and shows the locations of the seed flow rate sensor 322, a vacuum sensor 323 and fertilizer flow rate sensor 324.

In summary, this disclosure describes a system capable of monitoring and adjusting automatically its functions such as vacuum level in the seed metering unit and seed/fertilizer air flow, according to the planting speed and rates stipulated by the operator.

The system for example identifies if the machine is delivering a poor distribution of seed and fertilizer through the sensors on the row units, so when this problem appears, the system is able to adjust automatically the vacuum level and seed/fertilizer air flow until a good distribution is recovered.

With the system running in operation between the tractor and the planter (as shown in FIG. 1), the fertilizer air pump (i.e., fan) and seed air pump are responsible for transporting the fertilizer and seeds to the row units where sensors installed in each row unit monitor the deposition in the furrow. In one example, the same air pump is responsible for transporting the seeds to the seed meter installed in the row units which dose the seeds through the pneumatic system comprising a vacuum pump that generates a vacuum that is monitored by the sensor 323. The seeds are deposited in the furrow via the seed flow rate sensor 322 which monitors the seed delivery rate and the fertilizer is deposited via a fertilizer flow rate sensor 324.

The system collects all the sensor information and adjusts the vacuum level and seed/fertilizer air flow to provide an improved distribution.

As explained above, there may be one air pump for seeds and one air pump for dry fertilizer, or they may share the air pump by using an air splitter. When separate air pumps are used, they may be controlled separately, i.e., the seed air pump is controlled to achieve desired seed distribution whereas the air pump for fertilizer may be run at a constant speed.

Variations to the disclosed embodiments can be understood and effected by those skilled in the art in practicing the claimed invention, from a study of the drawings, the disclosure, and the appended claims. The word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

1. A seed delivery system, comprising:
a first storage vessel for storing first material to be provided to the ground, the first material comprising seeds;
a second storage vessel for storing second material to be provided to the ground;
a first distribution arrangement for delivering the first material to the ground, wherein the first distribution arrangement comprises a seed metering unit;
a second distribution arrangement for delivering the second material to the ground;
an air pump;
a first channel arrangement for delivering the first material from the first storage vessel to the first distribution arrangement using an air flow from the air pump;
a second channel arrangement for delivering the second material from the second storage vessel to the second distribution arrangement using an air flow from the air pump;
a sensor arrangement for sensing at least a seed flow rate to the ground and a second material flow rate to the ground; and
a controller for controlling the air pump, wherein the controller is configured to control the air pump in dependence on a desired seed delivery rate and a desired delivery rate of the second material, and using feedback from the sensor arrangement.

2. The seed delivery system of claim 1, wherein the controller is configured to control the air pump to control the air flow for the delivery of the first and second materials independently.

3. The seed delivery system of claim 1, wherein the seed metering unit comprises a seed disc having compartments for holding individual seeds, wherein the controller is further configured to control a rotation speed of the seed disc.

4. The seed delivery system of claim 3, wherein the seed metering unit comprises a vacuum pump for delivering a vacuum to the seed disc, wherein the sensor arrangement further comprises a pressure sensor for monitoring the vacuum level.

5. The seed delivery system of claim 3, wherein the controller is further configured to control the vacuum pump in dependence on the monitored vacuum level using feedback from the sensor arrangement.

6. The seed delivery system of claim 1, wherein the sensor arrangement comprises a pressure sensor for measuring a first pressure generated for seed transport and a second pressure generated for transport of the second material.

7. The seed delivery system of claim 1, wherein the sensor arrangement is further for measuring, or receiving, a ground speed of the seed delivery system.

8. (canceled)

9. The seed delivery system of claim 1, further comprising an air splitter for splitting an output air flow from the air pump between first and second outlets, wherein the air splitter comprises a controllable valve for controlling a splitting ratio between the first and second outlets, and wherein the first channel arrangement is for delivering the first material from the first storage vessel using an air flow from the first outlet and the second channel arrangement is for delivering the second material from the second storage vessel to the second distribution arrangement using an air flow from the second outlet.

10. The seed delivery system of claim 9, wherein the controller is further configured to control the air splitter.

11. The seed delivery system of claim 1, wherein the first and second distribution arrangements each comprise a set of distribution units, wherein the seed delivery system comprises a set of row units, each with a respective first and second distribution unit.

12. The seed delivery system of claim 1, wherein the second material comprises seeds and the second discharge arrangement comprises a seed metering system.

13. The seed delivery system of claim 1, wherein the second material comprises dry fertilizer and the second discharge arrangement comprises a fertilizer nozzle.
